(19) United States
(12) Patent Application Publication
(10) Pub. No.: US 2008/0122696 A1
(43) Pub. Date: May 29, 2008

(54) Low cost fire fighter tracking system

(76) Inventors: Steve D. Huseth, Plymouth, MN (US); Andrew G. Berezowski, Wallingford, CT (US)

Correspondence Address: Kris T. Fredrick, Esq.;Honeywell International Inc., 101 Columbia Road, Morristown, NJ, 07962, US

(21) Appl. No.: 11/605,685

(22) Filed: Nov. 28, 2006

(51) Int. Cl. G01S 3/02; G08B 23/00

(52) U.S. Cl. 342/464; 340/573.1

(57) ABSTRACT

A system for tracking persons and other objects in a structure in which a plurality of low power transmitter beacons send identifiers to any receiver within range of the beacons. The beacons are attached to the building at known locations that are used as reference points. The person or object carrying the receiver then uses the information of those beacons to determine the location in the structure of the receiver. The data can be sent to a command center or other monitoring location or it can be processed on site by the receiver.

### FIELD OF THE INVENTION

The present invention relates to a tracking system for tracking people and things in an environment. More particularly, the present invention relates to a tracking system for firefighters and the like using a plurality of low power beacons placed in the environment at known locations where each beacon sends a signal received by the people or things in the environment for processing.

### BACKGROUND OF THE INVENTION

In this information age, knowledge of the location of persons and things inside an environment such as a building or several buildings is becoming more important. While such knowledge is important, the cost of acquiring the data should not be prohibitive. Equipment that can send and receive signals to and from other equipment, then be processed to provide the desired information can be expensive. Reducing the cost of such systems is desirable.

For the purposes of this invention, the preferred embodiment is a system that tracks fire fighters and other rescue personnel. However, the person or object being tracked is not the essence of the invention and it is contemplated that other persons as well as objects, both large and small, can benefit from the same system. For example, a vehicle in an enclosed parking lot and a laptop computer sitting on a desk can both be the object of the tracking without departing from the scope of this invention.

Because of the dangers of fighting fires and other disasters in buildings, that embodiment is the focus of this background. Fire fighters are subject to a number of dangers, and his or her safety becomes paramount. In spite of all the precautions taken, numerous fire fighters are killed or severely injured as a result of becoming trapped or lost in a burning structure. Debris, smoke and falling walls make navigating within the structure extremely difficult. Many fire fighters have perished within 100 feet of safety due to their inability to find a route out of the building or rescue teams being unable to find the lost fire fighter in a timely fashion. Tracking these persons is desirable, and being able to do so at a reasonable cost is highly desirable, not only to save money but to encourage building owners to make an investment that would otherwise be prohibitive.

Radio Frequency (RF) based tracking systems rely on a combination of fixed beacons and mobile tags to track the movement of the tags, based on signal strength or time-of-flight measurements of specific RF signals. Near-continuous RF links with the beacons are necessary for the system to calculate timely location information. However, RF propagation variability may result in loss of path data for a mobile tag or tags. An alternative approach, which overcomes the RF link variability issue, employs a dead-reckoning module (DRM) in each mobile tag. The DRM can contain multiple sensors, such as altimeters, barometers, accelerometers, temperature sensors, and compass sensors, for example. The RF link is then used solely for data communications between the mobile tags and the base stations.

A number of solutions have been proposed for tracking and locating people and assets inside a building or structure using such a collection of location sensors that have been placed throughout a facility. These sensors use varying technologies to estimate distance to a mobile device that use techniques such as received signal strength indication (RSSI) and time of arrival (TOA). In each of these technical approaches, the accuracy of the distance measurement solution is directly proportional to the distance the mobile device that is being tracked is from the location sensing devices that have been placed throughout the facility. Furthermore, the accuracy is determined by having multiple location sensors in the vicinity of the mobile device. Consequently, for optimal performance, each of these location sensing techniques requires a large number of location sensors to be distributed throughout the facility roughly on a grid. The more sensors that are placed throughout the facility, the greater the accuracy of the location solution.

Placing a large number of location sensors on an evenly spaced grid throughout a facility can present a significant installation challenge. Each device must be connected such that it maybe powered and be able to communicate the location information sensed back to a gateway or display device where the location information may be displayed. This represents a significant installation challenge that can be extremely labor intensive and costly.

Accordingly, one advantage of the present invention is to provide a low cost system for tracking persons and things in an environment.

Other advantages will appear hereinafter.

### SUMMARY OF THE INVENTION

It has now been discovered that the above and other advantages of the present invention may be obtained in the following manner. In its simplest form, the present invention includes the use of a plurality of small low power transmitters attached to a structure such as a building at known location. The signal is received by the person or object inside the structure and used to identify the location of the person or object.

In one embodiment, the person or object receives signals from those beacons within the range of transmission of each beacon, relays the information to a command center or other data processing station, which in turn relays the information either or both to the person or object and to those monitoring the person or object. In another embodiment, the person or object processes the low power signals with equipment on location, and thus determines his or her or its location on site. In either case and in other embodiments, the mobile unit (person or thing) is the only receiving unit in the system.

The beacons that are attached in the structure are located at places in the structure where there is an artifact of known location that has been designed or installed in the building. It is essential that the location of the beacon with respect to the building be known. Smoke detectors, light fixtures, alarm panels, and entry pads are some examples of locations that are known and can be identified in the processing program. Any location that is identified on the architectural blue print or other plan of the structure is an appropriate location for a beacon in accordance with this invention.

The beacon itself is designed to send a low power signal that can be received over a reasonable range of distance, and because there are a plurality of beacons, the receiver carried by the person or object being tracked will be in the range of some of the beacons. The signal transmitted will include data that identifies the fixture to which the transmitter is attached so that the data will identify those fixtures and their locations that are received by the receiver. A simple process of triangulation precisely identifies the location of the receiver.

The signal strength can also be measured by the receiver or the processor to proximate the distance from a beacon to the receiver to further assist in calculating the location of the person or object.

The present invention is particularly suited for use in firefighting situations in buildings, where it is important to know the location and condition of each firefighter. As stated earlier, however, fire fighters are only one focus of the present invention and any other person or object is also contemplated for use in the present invention.

### BRIEF DESCRIPTION OF THE DRAWINGS

For a more complete understanding of the invention, reference is hereby made to the drawings, in which:

FIG. 1 is a schematic view of the present invention in which a person is inside an array of low power beacon transmitters at fixed locations known to the system and capable of identifying itself in the transmission.

### DETAILED DESCRIPTION OF THE PREFERRED EMBODIMENT

The present invention uses the technique of placing a plurality of small, low power transmitters or beacons, preferably wireless but also including hard wired transmitters, with objects located in a building or other structure where the location of placement is known. One embodiment comprises the placement of these beacons with smoke sensors or smoke sensor bases but other locations including light fixtures, key pads, fire alarm, CO₂ detectors and any other fixture about which the location is known with certainty and precision.

Typically during building construction, each smoke sensor (or other fixture as noted above) is precisely placed on an architectural drawing and uniquely identified. Spacing between smoke sensors (or other fixture as noted above) us precisely defined by building codes and/or other predetermined conditions. The beacon transmitter, preferably a RF transmitter, is designed to transmit its unique identifier. The transmission may be continuous or intermittent, such as every few seconds. Since the power level of the beacon transmitter is low, and because data acquisition from the fixture is minimal, minimum power is required by the beacon, which minimizes its cost. In addition, receiving multiple signals in the same vicinity and measuring the signal strength of each signal will allow a more precise location to be established, using triangulation calculations.

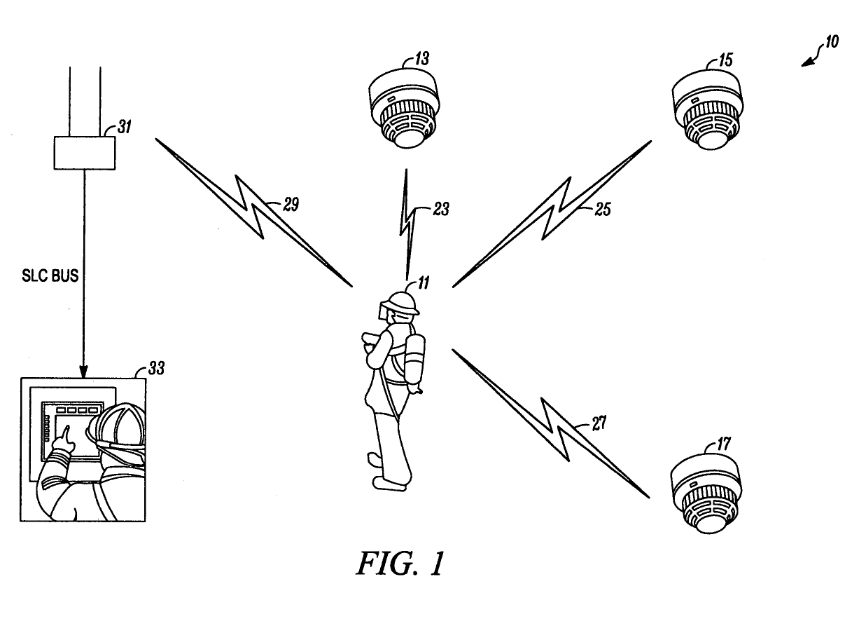

FIG. 1 illustrates the system, 10 generally, and method of this invention in a preferred embodiment where a fire fighter 11 is in a structure where smoke detectors 13, 15 and 17 are placed at known locations, as represented by the detector number shown proximate each detector. Also attached to the detectors 13, 15 and 17 are low power wireless transmitter beacons illustrated by transmissions 23, 25 and 27. The fire fighter 11 has a receiver/transmitter 29 which receives the signals from beacons whose signals are strong enough to reach the receiver portion 29 and are transmitted by the transmitter portion 29 to a processor 31 which then displays the data on display 33.

The beacons used in FIG. 1 use a low frequency transmitter of, for example, a radio at the 2.4 Ghz range. The beacon is also able to acquire the unique identification of the smoke detector or other fixture to which it is attached. The receiver/transmitter is in fact a combination of two components, where one component receiving signals from the beacons at the low frequency such as the 2.4 Ghz range noted above and one transmitting at a higher range, such as, for example, at 900 Ghz. It is important that the two frequencies be different enough to avoid interference between them. An alternative would be to use a single radio by synchronizing all the beacons and receivers, which would be more complicated. Other similar devices can be used to accomplish the goals of this invention. The receiver/transmitter may be integrated into the fire fighter's air pact or Personal Alarm System that is required for each fire fighter. Each time the receiver/transmitter receives a signal from a smoke sensor, it will retransmit its own message containing the identifier of the sensor together with the received signal strength indication or RSSI of the smoke sensor message and the unique identifier of the fire fighter. This will be transmitted at a much higher power and received by long range receivers placed in the building or directly in a remote command center, for example. The long range receivers receive the messages from the fire fighters and relay the information to a command console for integration and display. The integration console can use a variety of algorithms to integrate multiple messages received b a fire fighter from the adjacent smoke sensor. Using algorithms such as triangulation and multilateration, a precise position for each fire fighter can be established.

In a preferred embodiment, the receiver/transmitter or the Personal Alarm System will generate a signal when the fire fighter (or other person or object) is in need of assistance, such as if the fire fighter is disabled or trapped.

The present invention has been described in one embodiment as operating in a structure such as a building. Any structure that has a plurality of fixtures having precisely known locations is suitable for this invention, including, but not limited to office buildings, hospitals, factories, multiple and single residences, government and military facilities, airports, train stations, parking lots, ships and boats, and the like.

Another embodiment of the present invention is to include a GPS or global positioning system in the Personal Alarm System to continue tracking the person or object once it is outside the specified structure. The beacon transmitters described herein are wireless transmitters but in some instances a hard wire power source can be used, particularly if the fixture, such as a smoke sensor, is hard wired in the structure.

The present invention has been shown in a preferred embodiment in a structure where it is desirable to monitor the location of persons or assets inside the structure. As noted above, the present invention is particularly suited for use in firefighting situations in buildings, where it is important to know the location and condition of each firefighter. Each firefighter carries a mobile unit and is tracked by the command center. Each mobile unit or beacon identifies itself to the sensors or anchors within its range of transmission, and each of those sensors or anchors transmits the distance to the mobile unit and its own location to other sensors or anchors so that the signal hops within the wireless mesh to the gateway and monitor in the command center. When the firefighter encounters an adverse situation, such as an injury, for example, the mobile unit or beacon transmits a distress signal along with its location signal.

While particular embodiments of the present invention have been illustrated and described, it is not intended to limit the invention, except as defined by the following claims.

1. A system for monitoring the location of a person or object in a structure, comprising:
a plurality of beacons for transmitting low power signals containing a specific location of each specific beacon of said plurality of beacons, wherein said each specific beacon is installed within said structure, each said specific location being known;
a receiver on said person or object for receiving at least some of said signals and for re-transmitting said received signals;
a processor for receiving said re-transmitted received signals to calculate the location of said receiver and providing a signal representative of said receiver location.

2. The system of claim 1, wherein said receiver re-transmits said received signals at a frequency sufficiently high to avoid interference with said low power signals and wherein said plurality of beacons is powered from a hard-wired power source of said structure.

3. The system of claim 1, wherein said receiver re-transmits said received signals and a received signal strength indication (RSSI) of said received signals to a processor remote from said receiver and said signal representative of said receiver location is transmitted to said receiver.

4. The system of claim 1, wherein said receiver re-transmits said received signals to a processor remote from said receiver and said signal representative of said receiver location is transmitted to a monitoring unit remote from said receiver.

5. The system of claim 1, wherein said receiver is carried by a firefighter or rescue person and said plurality of beacons transmit a wireless signal and wherein said receiver includes a Global Positioning System (GPS) receiver.

6. The system of claim 1, which further includes an alarm for transmitting a signal upon recognition of a predetermined condition.

7. The system of claim 6, wherein said receiver is carried by a fire fighter and said alarm is activated when said fire fighter has become immobilized.

8. A system for monitoring the location of a person or object in a structure, comprising:
a plurality of beacon means for transmitting low power signals containing the specific location of each specific beacon means of said plurality of beacons means, wherein said each specific beacon of said plurality of beacon means is installed within said structure, each said specific location being known;
receiver means on said person or object for receiving at least some of said signals and for re-transmitting said received signals;
processor means for receiving said re-transmitted received signals to calculate the location of said receiver means and providing a signal representative of said receiver means location.

9. The system of claim 8, wherein said receiver re-transmits said received signals at a frequency sufficiently high to avoid interference with said low power signals.

10. The system of claim 8, wherein said receiver means re-transmits said received signals and a received signal strength indication (RSSI) of said received signals to a processor means remote from said receiver means and said signal representative of said receiver means location is transmitted to said receiver means.

11. The system of claim 8, wherein said receiver means re-transmits said received signals to a processor means remote from said receiver means and said signal representative of said receiver means location is transmitted to a monitoring unit remote from said receiver means.

12. The system of claim 8, wherein said receiver means is carried by a firefighter or rescue person and said plurality of beacon means transmit a wireless signal.

13. The system of claim 8, which further includes an alarm means for transmitting a signal upon recognition of a predetermined condition and wherein said receiver means includes a Global Positioning System (GPS) receiver.

14. The system of claim 13, wherein said receiver means is carried by a fire fighter and said alarm means is activated when said fire fighter has become immobilized.

15. A method for monitoring the location of a person or object in a structure, comprising:
providing a plurality of beacons for transmitting low power signals containing the specific location of each specific beacon of said plurality of beacons, wherein said each specific beacon is installed within said structure, each said specific location being known;
placing a receiver on said person or object in said structure for receiving at least some of said signals and for re-transmitting said received signals;
processing said re-transmitted received signals to calculate the location of said receiver and providing a signal representative of said receiver location.

16. The method of claim 15, wherein said receiver re-transmits said received signals at a frequency sufficiently high to avoid interference with said low power signals and wherein said plurality of beacons is powered from a hard-wired power source of said structure.

17. The method of claim 15, wherein said receiver re-transmits said received signals to a processor remote from said receiver and said signal representative of said receiver location is transmitted to said receiver.

18. The method of claim 15, wherein said receiver re-transmits said received signals and a received signal strength indication (RSSI) of said received signals to a processor remote from said receiver and said signal representative of said receiver location is transmitted to a monitoring unit remote from said receiver.

19. The method of claim 15, wherein said receiver is carried by a firefighter or rescue person and said beacons transmit a wireless signal.

20. The method of claim 19, wherein said receiver is carried by a fire fighter and an alarm is activated when said fire fighter has become immobilized.
